(19) United States
(12) Patent Application Publication
(10) Pub. No.: US 2010/0253283 A1
(43) Pub. Date: Oct. 7, 2010

(54) DEVICE FOR RECHARGING THE INTERNAL BATTERY OF A CELLULAR TELEPHONE

(75) Inventor: Damien Francois, Paris (FR)

Correspondence Address: HESPOS & PORCO LLP, 110 West 40th Street, Suite 2501, NEW YORK, NY, 10018, US

(73) Assignee: FIREFLY DEVELOPMENT LIMITED, Hong Kong (CN)

(21) Appl. No.: 12/496,236

(22) Filed: Jul. 1, 2009

(30) Foreign Application Priority Data
Apr. 3, 2009 (FR) 09 52167

(51) Int. Cl. H02J 7/00

(52) U.S. Cl. 320/114

(57) ABSTRACT

A device (10) is provided for electrically recharging the internal battery of a cellular telephone (20). The device (10) has a casing (11) containing power and current-transforming electronic components, a unit (13) for connecting to an external current source, of mains type, and a unit (14) for connecting to said cellular telephone. The device also includes a backup battery incorporated in the casing intended, on the one hand, to recharge the battery of the cellular telephone (20) when the device (10) is linked only to the latter and, on the other hand, to be recharged when the device (10) is linked at least to the external current source.

### BACKGROUND OF THE INVENTION

1. Field of the Invention

The present invention relates to a device for electrically recharging the internal battery of a cellular telephone.

2. Description of the Related Art

Current cellular telephones stack up numerous functions, all high energy consumers, such as the reading of audio/video files of different formats, satellite navigation, taking of snapshots or videos, synchronization with an office computer, connection to the internet, management of electronic mail (sending and receiving), diary, reception of television or radio, or even games.

Thus, with the accumulation of all these applications, some possibly also functioning simultaneously because these appliances now have a multitasking operating system, the power needs have significantly increased in recent years. However, this energy need has also been accompanied by a reduction in the general size of the appliance and therefore in the space reserved for the battery.

A few years ago, the usage time of a telephone for each recharge was a major marketing advantage (for example, 15 days on standby and 25 hours in use), but that is no longer, or rarely highlighted at the expense of the technical capabilities and multipurpose nature of the appliances, which have become increasingly comprehensive and complex.

Currently, it is often necessary to recharge a cellular telephone every 2-4 days on average, or even less, depending on the intensity of use, notably the use of energy resource-intensive applications such as satellite navigation or video playback.

One solution is to increase the number of chargers for each appliance. Thus, the user can have a charger in the home, one at work, another in his or her vehicle and, possibly, an emergency charger.

However, this solution is not at all cost-effective for the user, who has to increase the number of purchases, but also from an ecological point of view. In practice, this type of charger generally uses disposable and polluting alkaline batteries. From a practical point of view, it is also ideal to have this type of battery available, which is a constraining factor.

It is also possible to purchase a number of identical batteries but for various reasons, some cellular telephones are sealed.

One aim of the present invention is therefore to resolve the problems stated above, using a solution that is simple to implement, inexpensive, reliable and ecological.

### SUMMARY OF THE INVENTION

The subject of the present invention is a device for electrically recharging the internal battery of a cellular telephone, comprising at least:
a casing containing electronic power and current-transforming components,
a unit for connecting to an external current source, of mains type, and
a unit for connecting to said cellular telephone,

characterized in that it also comprises a backup battery incorporated in the casing and intended, on the one hand, to recharge the battery of the telephone when the device is linked only to the latter and, on the other hand, to be recharged when the device is linked at least to the external current source.

According to preferred embodiments, the device according to the present invention comprises at least one of the following characteristics:
the casing contains a protective film for separating the housing provided for the incorporated backup battery from the power electronics;
the film measures at least 0.5 mm thick and is made of rigid plastic material;
it comprises, visibly on the casing, at least one recharge indicator for the internal battery of the cellular telephone and a recharge indicator for the incorporated backup battery;
the power electronic circuit includes an element suitable for permanently detecting the state of charge of the internal battery of the cellular telephone and/or of the incorporated backup battery;
the incorporated backup battery has a direct current capacity at least equal to 1000 mAh at a voltage of 4 V and is suitable for delivering a direct current of 500 mAh at a voltage of 5.5 V;
the incorporated backup battery is a polymer-type battery; and
the connection unit between the casing and the cellular telephone is a Universal Serial Bus (USB) type cable.

The invention will now be described in more detail with reference to particular embodiments given by way of illustration only and represented in the appended figures.

### BRIEF DESCRIPTION OF THE DRAWINGS

FIGS. 1 and 2 are perspective views of a charger according to the present invention.

FIGS. 3 and 4 are views of the charger in use.

FIG. 5 is a front view of the charger.

FIGS. 6 and 7 are side view of the charger.

FIGS. 8 and 9 are partial cross-sectional views of the charger.

### DETAILED DESCRIPTION OF THE PREFERRED EMBODIMENT

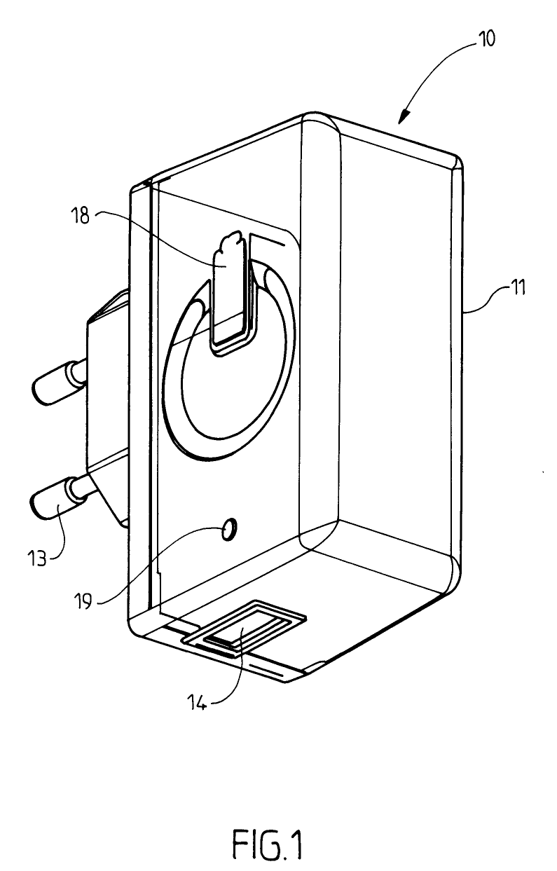

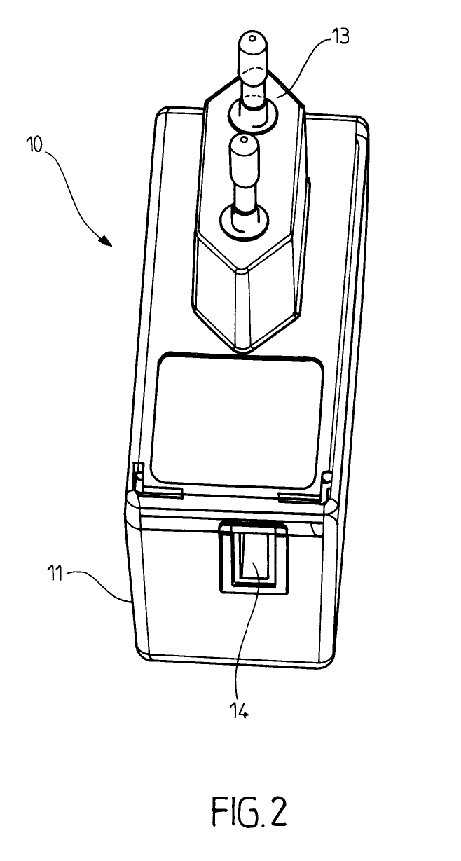

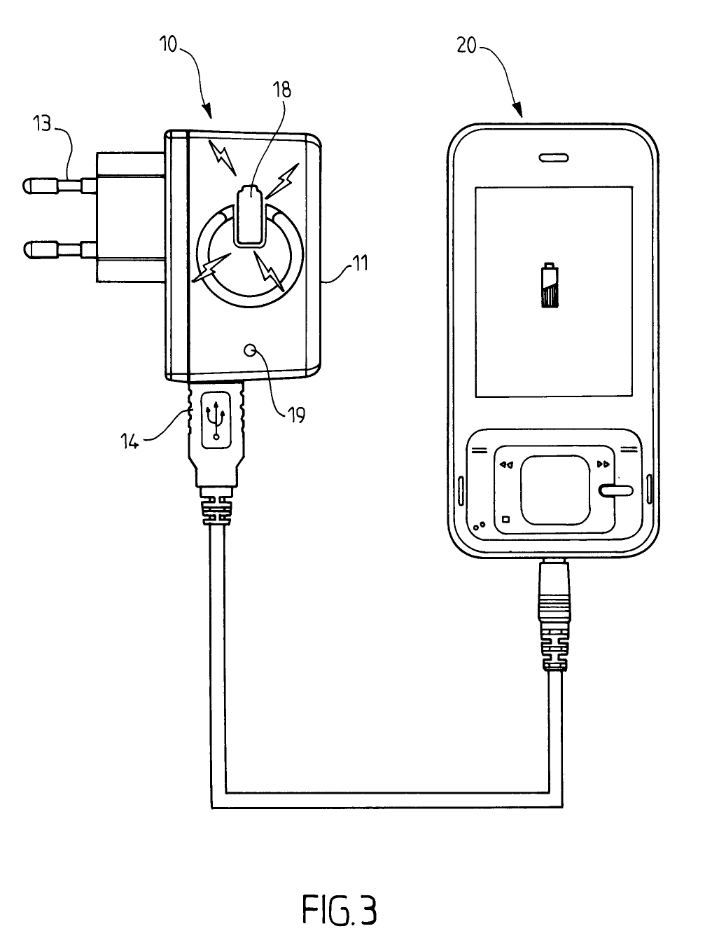

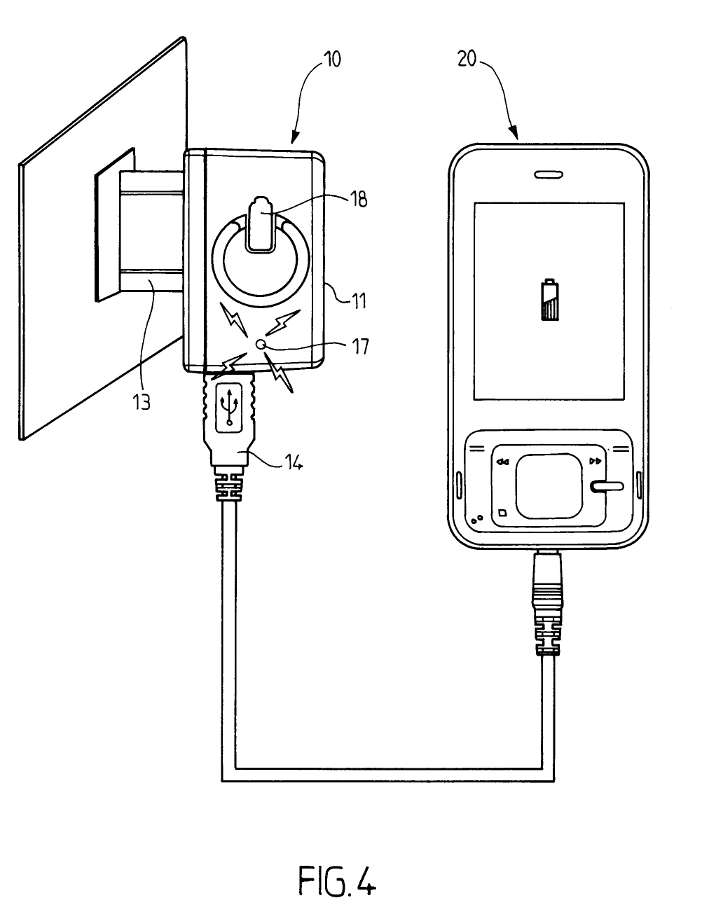

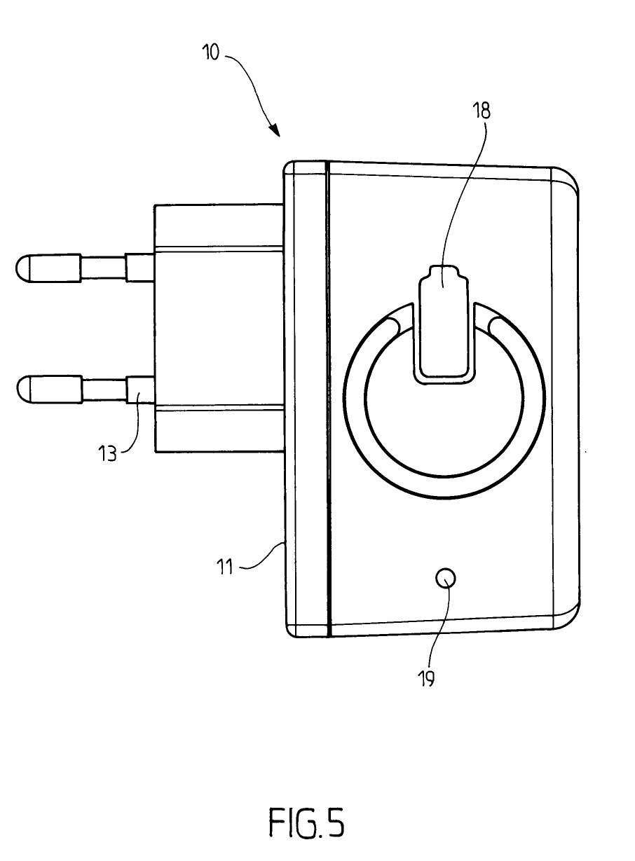

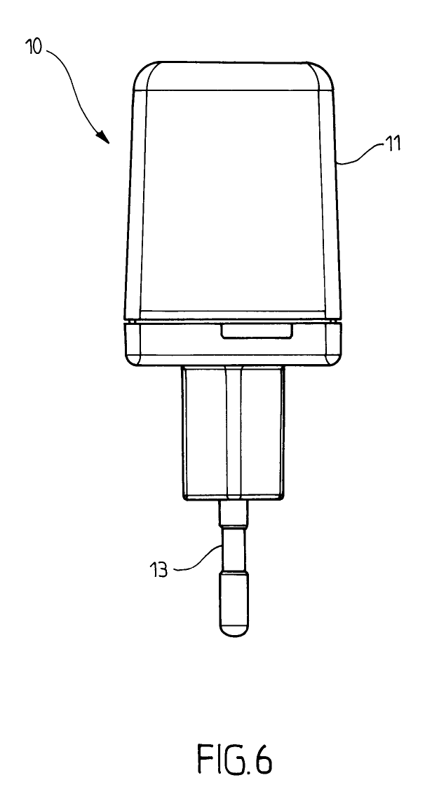

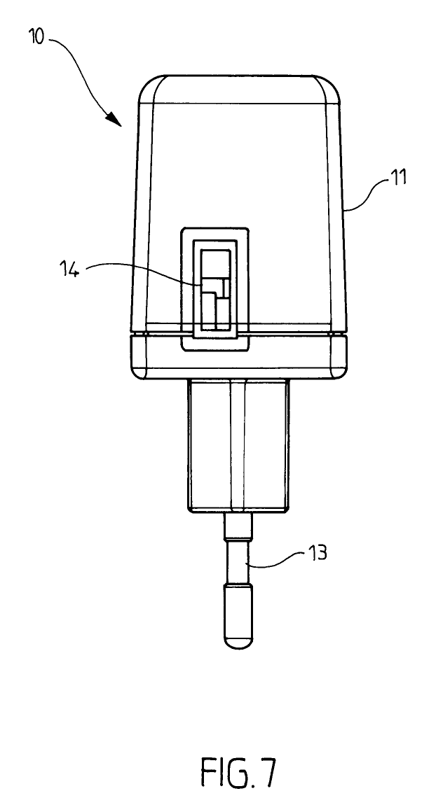

An electrical recharging device 10 for a cellular telephone 20 is represented in perspective in FIGS. 1 and 2 and in collaboration with said telephone in FIGS. 3 and 4.

This device 10, also called standalone charger, comprises a casing 11 containing power and current-transforming electronic components 12 of known type, a unit 13 for connecting to an external current source, for example an electric plug for connecting to the mains (110 or 220 V alternating current) and a unit 14 for connecting to the cellular telephone 20, for example a Universal Serial Bus (USB) type plug or equivalent (adaptors can be provided depending on the type of telephone).

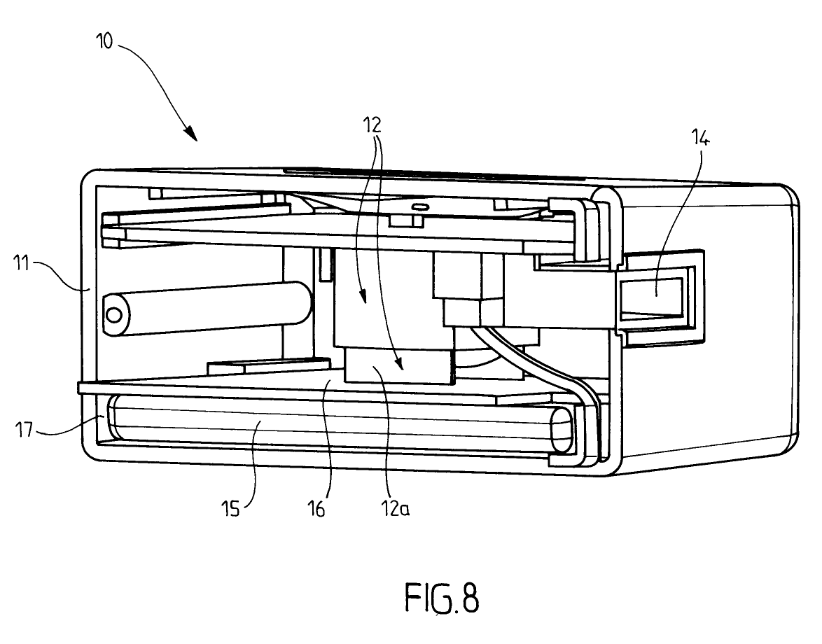

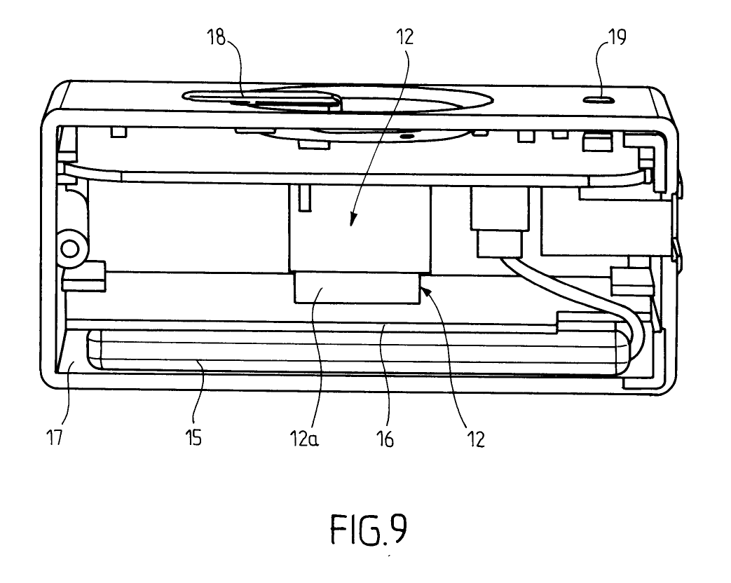

As can be seen in FIGS. 8 and 9, the casing 11 also contains a thin backup battery 15 of polymer type that can, for example, deliver 1000 mAh at 4 V. A DC/DC conversion circuit is also provided for it to deliver approximately 500 mAh at a voltage of 5.5 V in order to adapt to the battery of the cellular telephone.

As is explained in more detail hereinbelow, this backup battery 15 is intended on the one hand to recharge the internal battery of the cellular telephone 20 when the charger 10 is linked only to the latter (FIG. 3) and on the other hand to be recharged when the charger 10 is linked at least to the external current source (FIG. 4).

Advantageously, the casing 11 also contains a protective film 16 separating the housing 17 provided for the backup battery 15 of the power electronics 12. This film measures at least 0.5 mm thick and is made of rigid plastic material.

The casing 11 also includes, on a visible surface, at least a first recharge indicator 18 for the internal battery of the cellular telephone 20 and a second recharge indicator 19 for the backup battery 15, these visual indicators being, for example, diodes of different colors.

The power electronic circuit 12 includes a unit 12a suitable for permanently detecting the state of charge of the internal battery of the cellular telephone 20 and/or of the backup battery 15 so as to be able to switch automatically from recharging one to recharging the other.

Thus, thanks to the present invention, a single charger is necessary, which is used both as a standard charger connected to a 110 or 220 V current outlet and as a top-up charger for incorporated backup battery 15.

The user therefore has the initial battery of his cellular telephone 20 and a backup battery 15 which will more often than not be at least partially charged already, which helps out the user by recharging the battery of the telephone 20 without needing another current source (FIG. 4).

The product presented in this way works very simply and automatically. Once the charger 10 according to the present invention is connected to the mains via the plug 13, the charging of the battery of the telephone 20 begins automatically and a dedicated light indicator 18 lights up to inform the user.

When the internal battery of the cellular telephone 20 is charged, the user is informed thereof by the extinguishing of said light indicator 18 and the lighting up of the second light indicator 19 relating to the recharging of the backup battery 15 of the charger 10 via the mains.

The user can then disconnect his cellular telephone 20 from the charger 10 and use it while the backup battery 15 is recharging, or even completely disconnect the charger 10 and stow it away.

Should the internal battery of the cellular telephone 20 fail, the user can either use the backup battery 15 of the charger 10 as the main recharging current source (FIG. 4), or connect his telephone 20 to the mains via the charger 10 in order to recharge the internal battery by using the current delivered by the mains transformed by the charger to deliver 500 mAh at 5.5 V (FIG. 3).

When the backup battery is recharging the internal battery of the cellular telephone (FIG. 4), it also delivers approximately 500 mAh at a voltage of 5.5 V by performing a DC/DC conversion because it initially delivers an output voltage of 4 V.

It goes without saying that the detailed description of the subject of the invention, given purely by way of illustration, does not in any way constitute a limitation, equivalent techniques being also included within the scope of the present invention.

Thus, it is possible to envisage providing the device with a battery of different power, notably more powerful, to adapt to the greatest possible number of current and future cellular telephones.

The type of link 14 between the charger 10 and the cellular telephone 20 can be different from the Universal Serial Bus cable described.

What is claimed is:

1. Device (10) for electrically recharging the internal battery of a cellular telephone (20), comprising at least:
a casing (11) containing electronic power and current-transforming components (12),
a unit (13) for connecting to an external current source, of mains type, and
a unit (14) for connecting to said cellular telephone,
characterized in that it also comprises a backup battery (15) incorporated in the casing and intended, on the one hand, to recharge the battery of the cellular telephone (20) when the device (10) is linked only to the latter and, on the other hand, to be recharged when the device (10) is linked at least to the external current source.

2. The device of claim 1, characterized in that the casing (11) contains a protective film (16) for separating the power electronics (12) from a housing (17) provided for the incorporated backup battery (15).

3. The device of claim 2, characterized in that the film (16) measures at least 0.5 mm thick and is made of rigid plastic material.

4. The device of claim 1, further comprising, visibly on the casing, at least a first recharge indicator (18) for the internal battery (22) of the cellular telephone (20) and a second recharge indicator (19) for the incorporated backup battery (15).

5. The device of claim 1, characterized in that the power electronic circuit (12) includes an element (12a) suitable for permanently detecting the state of charge of the internal battery of the cellular telephone (20) and of the incorporated backup battery (15).

6. The device of claim 1, characterized in that the incorporated backup battery (15) has a direct current capacity at least equal to 1000 mAh at a voltage of 4 V and is suitable for delivering a direct current of 500 mAh at a voltage of 5.5 V.

7. The device of claim 1, characterized in that the incorporated backup battery (15) is a polymer-type battery.

8. The device of claim 1, characterized in that the connection unit (14) between the casing (11) and the cellular telephone (20) is a Universal Serial Bus (USB) type cable.
